(19) United States
(12) Patent Application Publication
(10) Pub. No.: US 2021/0027404 A1
(43) Pub. Date: Jan. 28, 2021

(54) SYSTEM AND METHOD OF REPUTATION MANAGEMENT AND CONTRACT MONITORING USING BLOCKCHAIN

(71) Applicant: Hatch Digital Inc., Toronto (CA)

(72) Inventor: Alejandro J. de Bold, Toronto (CA)

(73) Assignee: Hatch Digital Inc., Toronto, ON (CA)

(21) Appl. No.: 16/938,025

(22) Filed: Jul. 24, 2020

Related U.S. Application Data
(60) Provisional application No. 62/878,774, filed on Jul. 26, 2019.

(51) Int. Cl. G06Q 50/18; G06Q 20/40

(52) U.S. Cl. CPC G06Q 50/18; G06Q 20/401

(57) ABSTRACT

The present invention relates generally to contracts, and more particularly to a blockchain-based contract structure for particular use with service providers such as social media advocates, expert advice providers and other types of service providers like graphic designers and programmers. In particular, a Hyperledger Fabric blockchain network is provided to create, execute and monitor contracts between parties, particularly between parties desiring services to be provided or their agents and service providers.

### FIELD OF THE INVENTION

The present specification relates generally to contracts, and more particularly to a blockchain-based contract structure for particular use with service providers.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

Digital identity and reputation management on the Internet is an area of high risk with few, if any, comprehensive standards. Facebook (Instagram) and Twitter currently support closed systems for identify verification that recognize the top 1% of users. User generated content in the form of online reviews, recommendations and custom created content affect nine out of 10 purchases yet it is next to impossible to validate the individual contributors. As a result, both businesses and consumers rely on aggregate rates (hundreds if not thousands of reviews) aka the wisdom of crowds to make an informed decision. In some cases, businesses may seek to sponsor custom created content by influential consumers on the Internet known as Influencer marketing. Influencer marketing is a new type of advertising where individuals may use their own social media channels (e.g., Facebook™, Instagram™, WeChat™) to promote third party products and services. This new type of advertising is associated with three types of risk which are not addressed in the current state of the art in the marketplace. These risks are fraud, legal and regulatory compliance, and a systematic method of managing and monitoring the execution of an influencer campaign in multiple concurrent markets at the same time.

A significant issue related to user generated content and is fraudulent activity. Fraud may come in many forms. It may come in the form of fake reviews for products being added by third parties to an online product. It may be also inflated social media followers or subscribers through the use of automated bot accounts or by purchasing or creating fake accounts and false or automated content engagement with other advocates to increase the apparent engagement level of their content without accurately reflecting the real engagement and likelihood of users to adopt the brand promoted by the influencer. Generally speaking, user generated content and identity verification are subject to significant abuse. This in turn erodes trust in any platform and services therein.

Legal and regulatory compliance risks for business exist in virtually every sector. One such example is when brands seek to promote or sell a product or service to consumers they are subject to laws regarding compliance for privacy or claims that can be made regarding the efficacy of a product and those laws change depending on the country or region. Within the global financial markets there are rules governing each country and complex software solutions which monitor compliance. There is a well-known financial requirement called “KYC” Know Your Customer. KYC exists for money transfers so business do not enable things such as money laundering. A KYC solution does not currently exist for marketing services as it relates to legal and regulatory compliance. Another example of regulatory compliance is adverse event reporting regarding consumer goods. Consumer packaged goods companies are required within Canada and the United States to report an adverse reaction to product within 48 hours of discovery. Another example is monitoring compliance of an influencer with the terms of a contract on behalf of a marketing agency. Potential violations of terms in a standard contract may include posting content on social media that could be damaging to a brand, posting content on behalf of a competitive product, or failing to complete the obligations within the contract.

Finally, a systematic method of managing and monitoring execution and adherence to contract terms is generally lacking in part as user generated content happens with such speed and frequency that current systems cannot keep up with the aforementioned legal and regulatory compliance requirements. Thousands of agreements are signed every day between brands or their respective agencies and the advocates around the world and are still often physically-signed paper contracts with little to no integrated compliance. Global brands from publicly traded companies have tightly integrated supply chain management and finance platforms for vendors but lack a similar solution to handle influencer and marketing services. As a result, global brands do not have a consistent solution to manage and monitor contract compliance and execution from a fraud, legal and regulatory compliance framework.

Furthermore, such a method of managing and monitoring execution and adherence to contracts would also be useful with other types of service providers aside from advocates, for example, people that give advice about a branded product or other service providers. It would be desirable to have a system of creating and monitoring contracts for marketing advocates and other types of service providers that addresses one or all of the above risks across an entire vendor supply chain.

Brands (or businesses) that are the demand side of the marketplace (seeking the services of others) are also subject to differing levels of quality and trust. Not all brands that hire advocates pay their bills or are easy to work with. There are multiple examples where suppliers are rated which include When a consumer uses a ride sharing company like Uber™ riders have the ability to rate the driver. Buyers have the ability to rates sellers on eBay™ and Amazon™ because there are millions of businesses on these platforms and many engage in fraudulent activity, such as selling fake goods. Businesses are also rated on platforms such as Glassdoor™ which rate the corporate culture and their CEO's ability to lead. A multi-party platform as proposed herein would allow contracts (advocates, suppliers) to rate the business in the same cryptographically secure trustworthy fashion.

Accordingly, there remains a need for improvements in the art.

### SUMMARY OF THE INVENTION

In accordance with an aspect of the invention, there is provided a cryptographically secure system or platform, which according to an embodiment uses Blockchain, for particular use between businesses who wish to contract service providers such as social media advocates, expert advice providers and other types of service providers, for instance, graphic designers and programmers and in turn the work product is consumed directly or in-directly by a third party (for example a consumer receiving advice). Each party represents a node within the system and each activity executed within the system represents a transaction which can be used to derive a numerical score stored in a cryptographically secure fashion which in turn can be verified mathematically by any party on the system.

According to an embodiment of the invention, there is provided a blockchain network to provide cryptographically verified identities which in turn allows parties create, execute, monitor, and validate contracts between parties, particularly between parties desiring services to be provided or their agents and service providers.

According to a further embodiment of the invention, there is provided a system of multi-party contract monitoring and compliance, comprising: a user interface, the user interface providing account creation and system access for individual and business users; an application layer including access to contract creation, revision and approval tools; and a blockchain network including a component for monitoring contract term compliance by contracting parties and a My Trust Score™ component to assign a My Trust Score™ to each party based on monitored contract compliance, wherein the contracting parties include a party desiring services to be provided or its agent and a service provider.

According to a further embodiment of the invention, there is provided a method of assigning a My Trust Score™ to a service provider, a business, or a designated agency (for example an agency acting on behalf of a business) computed by assembling a series of values which may include; contracts (the length, duration, and value) for each closed or ongoing contract in which multiple parties have entered into agreement with a party desiring services to be provided or its agent: determining whether any proof of work has been submitted by the service provider, if yes, determining using machine learning or artificial intelligence whether the proof of work submitted by the service provider is in full or partial compliance with the terms of the contract, and assigning a compliance score based on a set of predetermined values explicitly defined within a contract (for example, timely delivery of services) or attributes associated with the performance of the contract (for example, NPS ratings of the service provider); and aggregating the compliance scores from each of the closed or ongoing contracts and assigning a My Trust Score™ to the service provider based on the aggregated compliance scores. As a result of the systems design, a significant advancement over prior art allows competitive businesses to engage in transparent but secure commerce.

It must also be noted that Hyperledger Fabric is one of many different technologies that could be used to create a cryptographically secure multi-party ledger and that the present disclosure does not preclude achieving the same goal using similar or like related technologies.

According to a further embodiment of the invention, each entity or node on the network has the ability to verify and enhance their identity. Any entity on the network has the ability to submit data or link to external networks to validate their identity. For example, an individual may link their social media accounts (Facebook, Instagram, Twitter) in order to establish their digital identity; an individual may choose to participate in a background check by providing a driver's license to establish their physical presence in the real world; an individual may choose to submit third party accreditation, such as a diploma, to establish subject matter expertise; an individual may complete an online course and submit a digital certificate each of these steps when completed are verified and encrypted to that individual's digital identity/hash on the blockchain which in turn increases their My Trust Score™ and can be verified mathematically on the network. The same aforementioned steps regarding identify verification are equally applicable to a business, brand or agency.

According to a further embodiment of the invention, service providers or business may also have explicit non-numerical values attached to their identity. Once an identity has been validated each entity is assigned a unique ID similar such as “2cd3acc4580d4e48a8c53d7cb35857d47eaa3099e10c388076041675863f09d0” on the network on Peer 1. Once an entity is assigned an ID centralized on Peer 1 on the ledger they may apply to join other peers/nodes (Peer 2, 3, 4, etc.) which can represent incremental attributes that can be added such as area of expertise. For greater clarity, if an individual joined the network, validated their identity, and submitted proof of accreditation as a dermatologist then they may have that attributed attached to their identity and join a second peer on the chain which is specific only to accredited dermatologists. As such, any contracts posted within the network where a specific skill, such as dermatologists, will only be available to those who are verified and part of that peer. In the event that a dermatologist engages with a consumer on behalf of a third party (for example online consultation during an e-commerce transaction) the consumer would be able to validate the identity of the dermatologist using this system due to the auditable and cryptographically secure nature of the platform this. In some embodiments, the validation happens within the system as the system checks to see if User X represented by Hash Y has the permissions to answer questions that are part of Peer Z (e.g., Peer Z being the node representing dermatologists), for example. This represents a significant improvement over prior art.

According to a further embodiment of the invention, there is provided a method of assigning a My Trust Score™ to a service provider. An aggregate benefit of deploying a mathematically secure multi-party solution over traditional data solutions is that any party can audit and validate authenticity of the data written to any party within the node. In a traditional open relational database system, there is no consensus or method of validating data submitted by third parties which reveals personally identifiable or proprietary data (trade secrets). Data and identity validation is the achilleas heel of fake online content, third party enterprise ratings solutions due to the fact that identity validation is limited to the browser on 1:1 bases—in many cases it is a unique browser fingerprint. The proposed system allows each party on the network to validate a universal set of transactions and share enriched transactional data. For example, Pepsi™ and Coke™ may be competitive businesses and may have their own internal algorithms for determining a My Trust Score™ with their suppliers. For example, the Pepsi™-generated My Trust Score™ can be stored on a sub-ledger that is private to Pepsi™, but both Pepsi™ and Coke™ can submit a global values to a shared master ledger for validation and as such the system represents an advancement over prior art. Balancing the need for privacy and trust regarding My Trust Scores™ for publicly readable My Trust Scores™ can be achieved through multiple cryptographic methods including but not limited to: zero knowledge proofs, multi-party computation, or homomorphic encryption. Each of these methods can help maintain data privacy and integrity.

For purposes of summarizing embodiments of the technology, certain aspects, advantages, and novel features of embodiments of the technology have been described herein. It is to be understood that not necessarily all such advantages may be achieved in accordance with any one particular embodiment of the technology. Thus, the technology may be embodied or carried out in a manner that achieves or optimizes one advantage or group of advantages as taught herein without necessarily achieving other advantages as may be taught or suggested herein. The features of the technology which are believed to be novel are particularly pointed out and distinctly claimed in the concluding portion of the specification. These and other features, aspects, and advantages of the present invention will become better understood with reference to the following drawings and detailed description.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a block diagram of a blockchain-based contract system according to an embodiment;

FIG. 2 is a block diagram of an application according to the system of FIG. 1;

FIG. 3 is a block diagram of a blockchain-based contract system according to an embodiment;

FIG. 4 is a block diagram of an individual entity interface according to the system of FIG. 3;

FIG. 5 is a block diagram of a business entity interface according to the system of FIG. 3;

FIG. 6 is a block diagram of an agency entity interface according to the system of FIG. 3;

FIG. 7 is a block diagram of a smart contract creation interface according to the system of FIG. 3;

FIG. 8 is a block diagram of a smart contract administration interface according to the system of FIG. 3;

FIG. 9 is a block diagram of a My Trust Score™ system according to the system of FIG. 3;

FIG. 10 is a block diagram of a trust ranking system according to the system of FIG. 9;

FIG. 11 is a diagram showing the flow of interaction between trusted advocates, staff of various brands and customers in the system according to an embodiment;

FIG. 12 depicts workflows between a freelancer, a platform, TrustScore, a brand and an agency according to an embodiment;

FIG. 13 depicts workflows between a brand, an agency, a freelancer, a customer, a marketing channel, a platform and a social media account according to an embodiment;

FIG. 14 is a diagram depicting the various methods a My Trust Score™ can be calculated according to an embodiment;

FIG. 15 is a block diagram of a business entity interface according to an embodiment;

FIG. 16 is a block diagram of a smart contract creation interface according to an embodiment;

FIG. 17 is a block diagram of a My Trust Score™ system according to an embodiment; and

FIG. 18 is a schematic diagram of a trust ranking system according to an embodiment.

Like reference numerals indicate like or corresponding elements in the drawings.

### DETAILED DESCRIPTION OF THE EMBODIMENTS

The present disclosure relates generally to contracts, and more particularly to a blockchain-based contract structure for particular use between parties desiring services to be provided and service providers. For instance, the technology described herein may be used in conjunction with marketing programs including work with brand promoters such as social media advocates or others who will promote a brand such as third party contractors acting on behalf of a brand or agency acting for a brand in sampling distribution, marketing promoting, creating advertising assets and other forms of promotion for a brand. It also may be used with other types of service providers including expert advice providers, graphic designers, programmers and others.

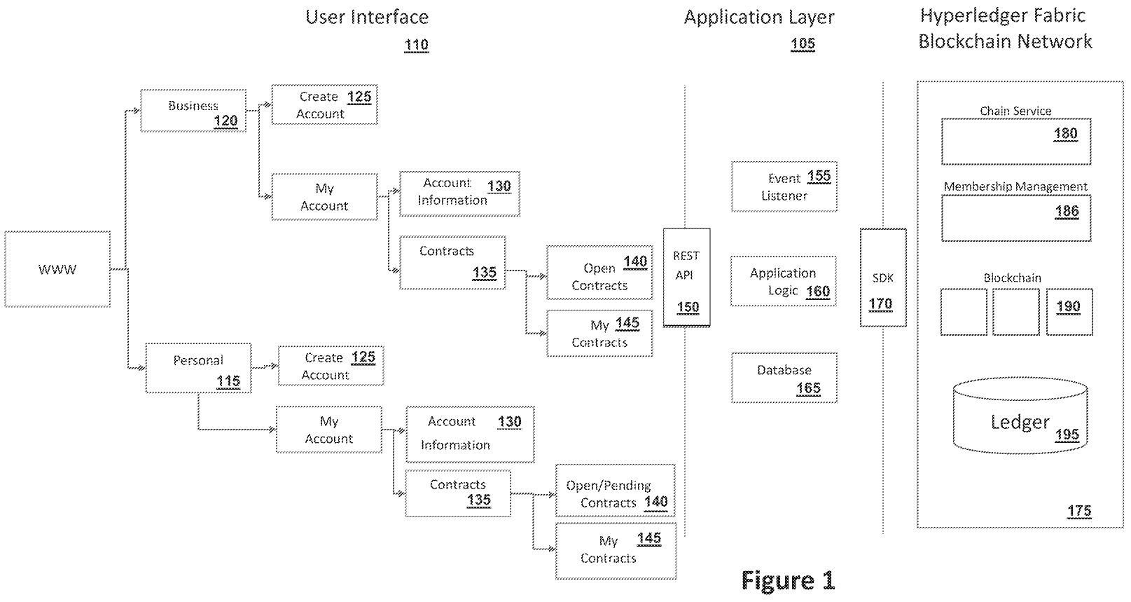

According to a particular embodiment as shown in FIGS. 1, 2 and 3 a contract monitoring system comprising a blockchain network 175 is provided to create, execute and monitor contracts between parties, particularly between brand holders (or their agents) and brand promoters such as social media advocates or others who will promote a brand. Within this network, two types of users are identified: business users 120, typically corporations who own or control one or more brands and products associated with the brands, and personal users 115, typically freelancers, for instance, social media advocates, that is, persons with social media accounts (Facebook, Instagram, etc.) that have a large number of followers and demonstrate a strong level of engagement with those followers.

The system is accessed by users through a user interface 110, which is preferably customizable based on the type of user and the user preferences. For each user, an account is created 125 which contains the user information 130 associated with the account, as well as the terms of all contracts 135 associated with the user, including pending contract offers 140, open contracts awaiting approval 140, active contracts 145, and closed or terminated contracts 145. The user interface 110 and application layer 105 can send and receive data to each other using a REST API 150. Applications may be created in the application layer 105 using a software development kit 170 allowing for configuration of a blockchain network. Each party may have an ownership of its own digital key via cloud-based instances for enterprise or mobile wallets for individual users on the platform.

The system further includes an application layer 105 which may include an event listener 155 for monitoring activities on the blockchain 190, along with the supporting application logic 160 and databases 165 to support and log events. Lastly, there is the blockchain network 175, preferably a Hyperledger Fabric blockchain network, which includes the chain service component 180, membership management component 186, the blockchain 190 and the ledger 195. The configuration of the blockchain 190 may include differentiating between primary permissions to access and modify, generally assigned to the chain owner, the chain administrator, and certain classes of user, including brand (business) users, regulatory users, legal users and financial users. Additionally, permission may also be provided for use partners, such as agencies and vendors.

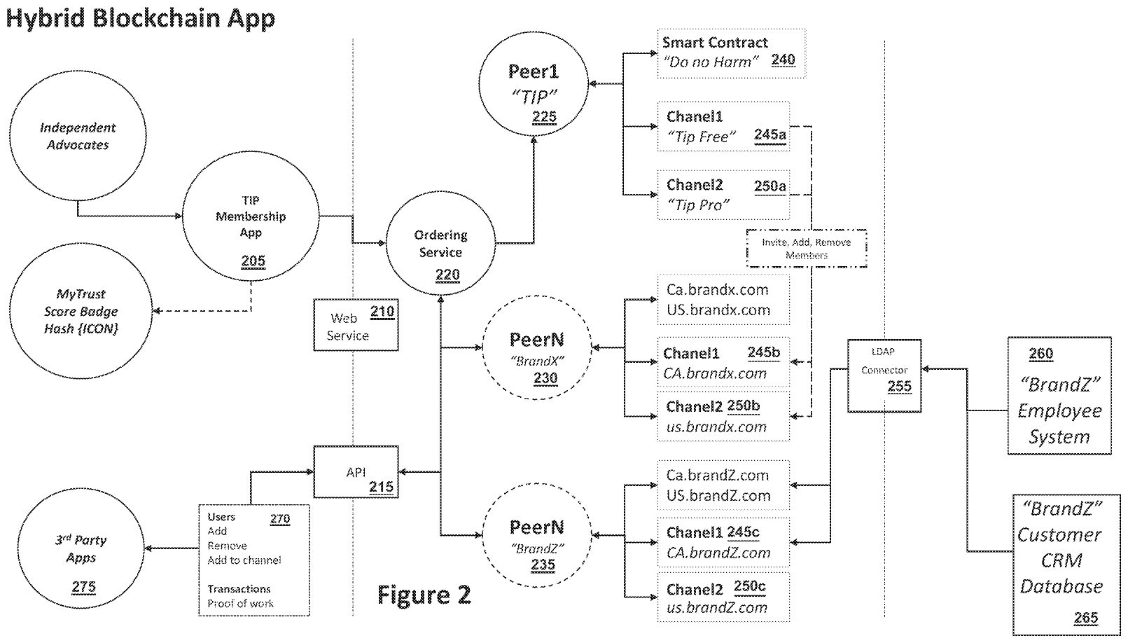

As shown in FIG. 2, the application layer may include both web services 210 and APIs 215 to control membership, adding/removing users 270, and interaction with third party applications 275. Other elements may include a user My Trust Score™ (discussed further below) and the ordering and tracking of brand usage (BrandX 230, BrandZ 235, etc.), including regional tracking (e.g., by country, shown as CA/US). The application layer may include a membership app 205 that receives data input and transmits data to a blockchain network. For example, membership app 205 can allow a user to access an ordering service 220. In some embodiments, an ordering service 220 can allow access to one or more Peers or nodes (e.g., nodes 225, 230, 235) on a blockchain network. The nodes (e.g., 225, 230, and 235) may be controlled by a brand or business entity, for example. Each node (e.g., 225, 230, and 235) may each have permissioned access (e.g., implemented by a Hyperledger Fabric blockchain) to one or more channels (e.g., 245a, 250a, 245b, 250b, 245c, and 250c) that are private to the respective node 225, 230, or 235 and/or to one or more smart contracts 240. In some embodiments, other users, such as an employee system 260 or customer CRM database 265, can access the blockchain network (e.g., the nodes, channels, and/or portions of or the entire ledger) through a lightweight directory access protocol (LDAP) connector 255.

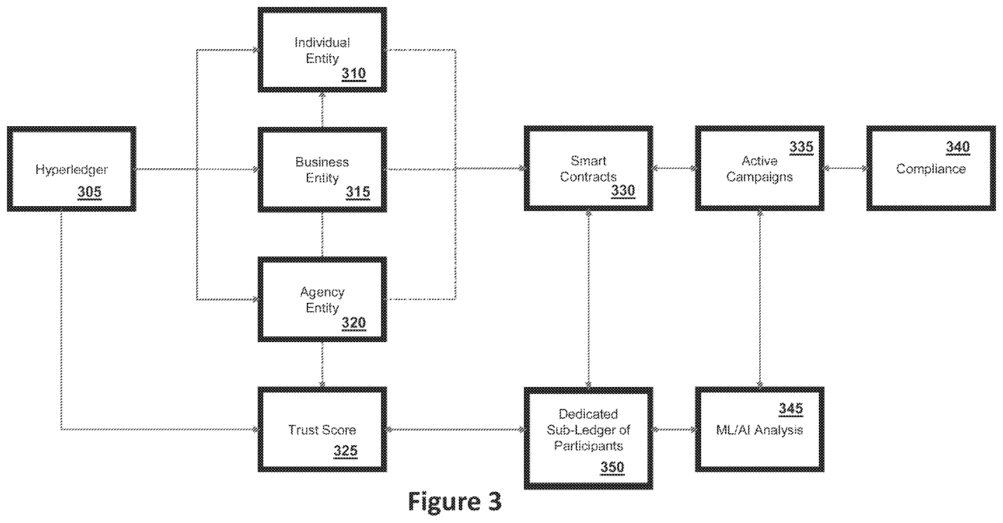

Referring to FIG. 3, the Hyperledger 305 tracks participants as one of three types of entities: individuals 310, businesses 315 and agencies 320. Each entity is potentially associated with a My Trust Score™ 325, and to one or more smart contracts 330. The smart contracts 330 have an associated sub-ledger 350 identifying the contract participants and are tracked as being active campaigns 335. Where a contract is associated with an active campaign 335, compliance 340 with the contract terms is monitored, and machine learning or artificial intelligence (AI) analysis 345 may be applied to identify compliant and non-compliant behaviors by participants. In some embodiments, the machine learning or AI can implement natural language processing libraries.

This data may then be fed back into the My Trust Score™ 325 calculation for the associated entities.

Contract compliance may be managed in many forms through AI based machine learning or specific events/actions defined by a contract that may be configured through cloud functions that monitor specific actions or behaviors such as: monitoring content created or posted by a contract participant to enforce employment exclusivity (e.g., accepting a contract from Nike™ for social media posts which prohibits any content posts for competitors), monitoring content created to ensure that it complies with regulatory compliance such as paid content disclosure, similar to the Food and Drug Administration (FDA) guidelines or reporting guidelines for adverse events as set out in the food and drug acts of various governments as they may vary by country. Content monitored by AI may come in forms that include text, images, and/or video.

Blockchain-based smart contracts and machine learning/AI may be combined to offer a significant advantage over the prior art in so far as they provide a technical platform that is flexible enough to be configured in a multi-party multi-market environment and at the same time offer irrefutable tracking and compliance.

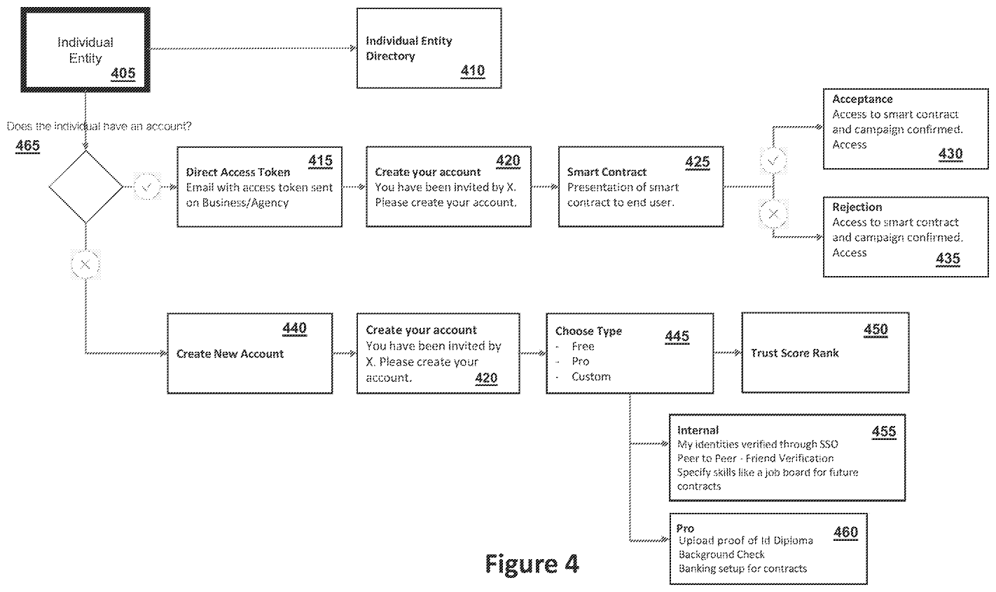

Account access and creation for individuals, businesses and agencies is shown in FIGS. 4, 5 and 6, respectively. Generally, after account creation 420, direct access tokens are provided to permit direct access to contracts associated with that user. In some embodiments, over time, a user may generate access to new peers, not unlike membership to different chat channels on an instant messaging platform, based on their skills or attributes. If a contract is created and published as “open”, all participants on the work may view the contract. If a contract is published as “closed” then it may be specific to a particular peer or skillset. Additionally, a contract may be specific as “invite only” in which only specific users have access to the platform.

FIG. 4 is a schematic diagram of an example workflow for an individual entity or user 405 interacting with the system, according to some embodiments. For example, at 465, the system determines whether the individual entity 405 has an account.

If yes, at 415, a direct access token (e.g., via email with access token) is sent. Next, at 420, the system creates an account (e.g., invites the user 405 to create the account and indicates who has invited the user 405 to create the account). At 425, the system presents a smart contract to the user 405. The smart contract can be received upon request with pertinent data relating to the user 405 from the ledger in a blockchain network, for example. At 430, the user 405 can accept the smart contract, for example, indicate agreement to its terms. The blockchain system can commit the acceptance to the ledger and/or configure permissions to allow the user 405 and/or other parties to the contract access to the contract and related information such as status and compliance indicators. At 435, the user 405 can reject the smart contract, for example, send data indicating non-agreement to its terms. The blockchain system can commit the rejection to the ledger and/or configure permissions to, for example, prevent the user 405 and/or other parties to the contract from accessing the contract and related information. Alternatively, data indicating a rejection of the smart contract can be sent to one or more other parties (e.g., other parties to the contract) and the one or more other parties can revise or manipulate the contract (or related data) at the application layer and the system can re-present the revised smart contract at 425 to the user 405.

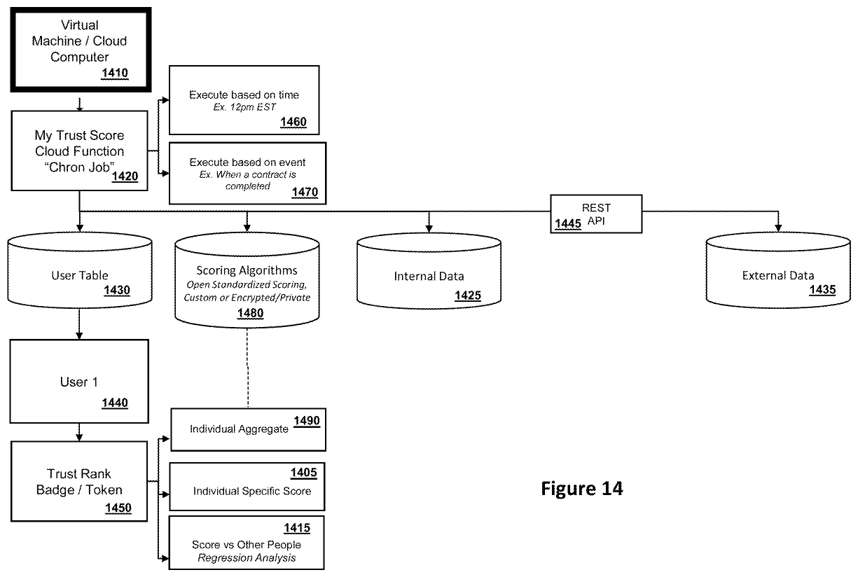

If, at 465, the system determines that the individual entity 405 does not have an account, the system creates a new account 440 and, in some embodiments, commits the new account data to the ledger in the blockchain. In particular, account creation 440, in some embodiments, includes transmitting message data at 420 inviting the user 405 to create an account; allows the user 405 to select the type of account to be created at 445 (e.g., free, pro, custom) and/or other account-related configuration; and requests, generates, and/or receives a My Trust Score™ rank at 450 for the user 405. In some embodiments, the My Trust Score™ rank determined at 450 is generated based on function 1520 as described in FIG. 14. At 445, the type of account can be configured as a Pro account at 460 if appropriate data is received and/or verified, such as uploaded proof of identity, receipt of diploma data, background check data, and/or banking setup for contracts. At 445, the type of account can be configured as an Internal account if appropriate data is received and/or verified, such as identity data verified through single sign on authentication (SSO), peer to peer friend verification data, and/or data specifying the user 405's skills that may be used in a job board for future contracts.

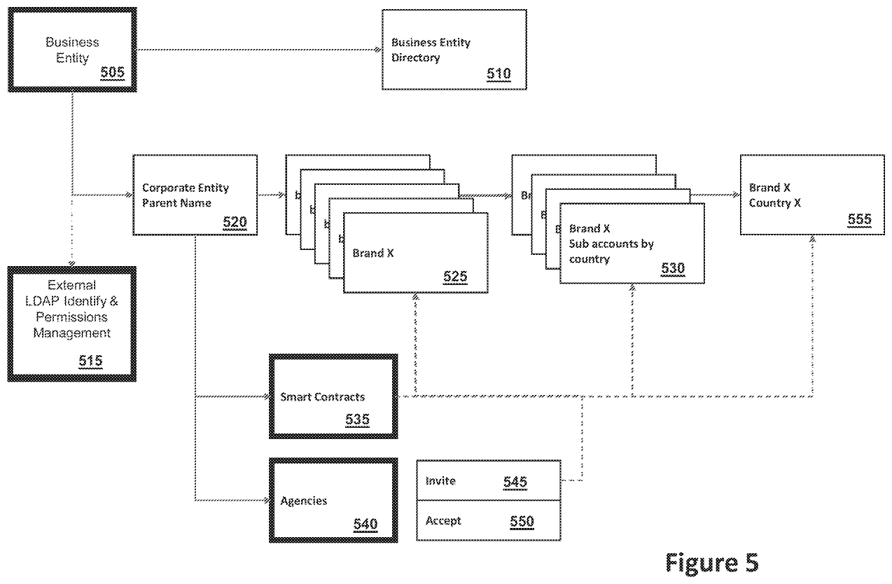

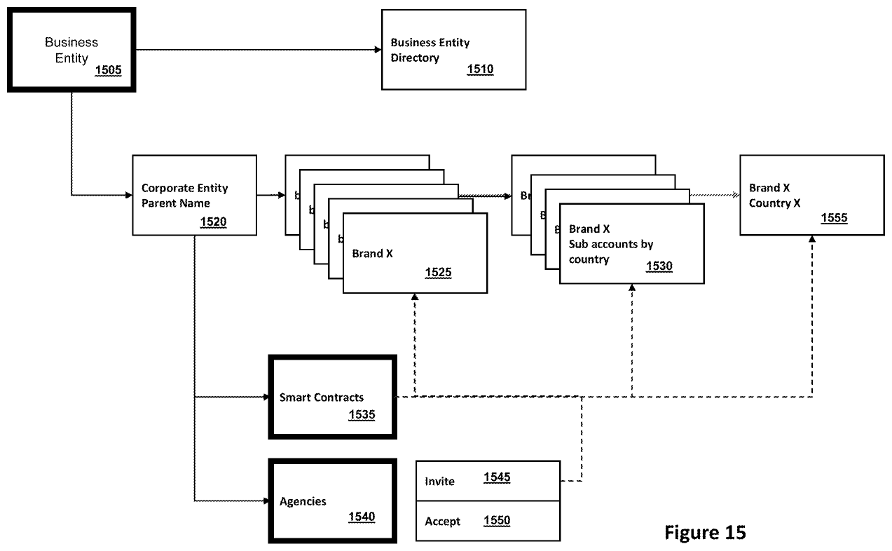

FIG. 5 is a schematic diagram of an example workflow for a business entity 505 interacting with the system, according to some embodiments. Data relating to the business entity 505 can be stored in a business entity directory 510 (e.g., database in a storage unit; memory) and may include a corporate entity parent name 520, information about one or more brands 525, account information 530 (e.g., by country) for each of one or more brands, and brand or country information 555. Associations between this data can be stored, for example, in a relational database. This data can be used in one or more smart contracts 535 or to administer/manage smart contracts 535, as well as can be used by one or more agencies 540, for example, that wish to enter into a smart contract with a particular business entity 505. For example, an agency 540 can invite 545 and/or accept 550 an invitation to enter into a smart contract 535. The invitation and acceptance process can be mediated through request, acceptance, and rejection data sent and received through or by a user interface and application layer. In some embodiments, a blockchain system (e.g., Hyperledger Fabric) implements a LDAP identity and permissions management 515 that can prevent or allow access by the business entity 505 to smart contracts, inviting agencies 540 to enter into smart contracts, and/or committing data about the business entity 505 to the ledger. FIG. 15 is a schematic diagram of an example workflow for a business entity 505 interacting with the system similarly to that described in relation to FIG. 5 at 1505, 1510, 1520, 1525, 1530, 1535, 1540, 1545, 1550, and 1555. In some embodiments, as shown in FIG. 15, the business entity's 1505 access is not managed by an external LDAP identity and permissions management unit.

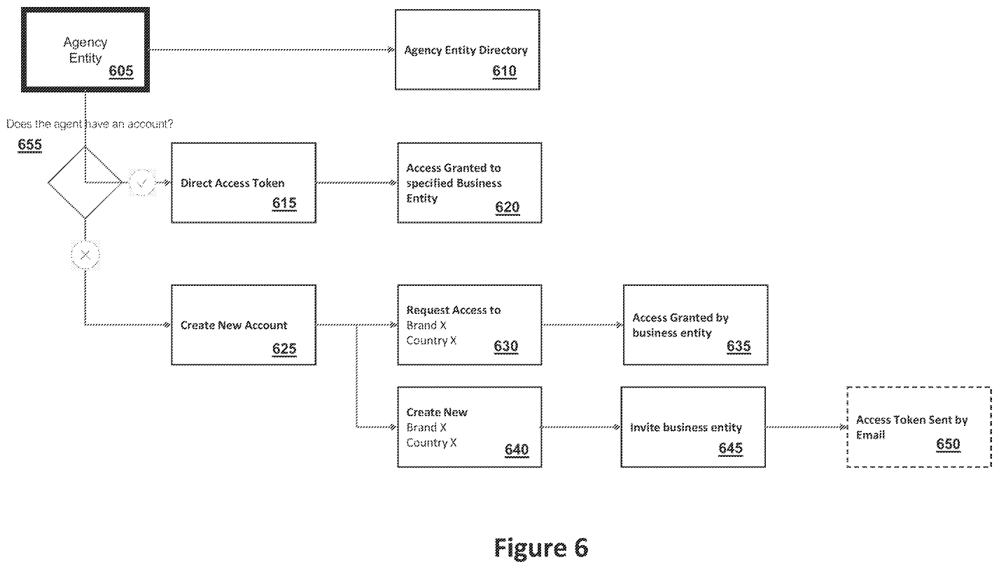

FIG. 6 is a schematic diagram of an example workflow for an agency entity 605 interacting with the system, according to some embodiments. Data relating to agency entity 605 can be stored in agency entity directory 610 (e.g., database in a storage unit; memory). Agency entity 605 can access the system, for example, through an application layer. In some embodiments, the application layer determines whether the agency entity 605 has an account at 655. If yes, at 615, a direct access token is generated and provided to agency entity 605 (e.g., committed to the ledger and/or sent to agency entity 605). The direct access token can be provided to the system and processed by the system to grant access at 620 to the agency entity 605 or to a specified business entity. If, at 655, the application layer determines that the agency entity 605 does not have an account, at 625, the system creates a new account. In some embodiments, the new account is configured to include a request for access to a specified brand and/or country at 630. The system can grant the requested access to the account. For example, the system can receive the request, transmit a request to a business entity (e.g., related to the brand and/or country that access is requested to) for approval, and grant access to the account upon approval by the business entity. In some embodiments, the new account is configured to include a request to create a new brand and/or country at 640. The system can invite at 645 one or more business entities based on the request to create a new brand for a country. In particular, the system can transmit an access token to the relevant business entity. In some embodiments, the access token is used by the system to allow the business entity to access one or more parts of the ledger in a blockchain system, and data relating to the access token can be committed to the ledger.

As described herein, an entity (e.g., individual entity, business entity, agency entity) is a computer or node controlled by the entity.

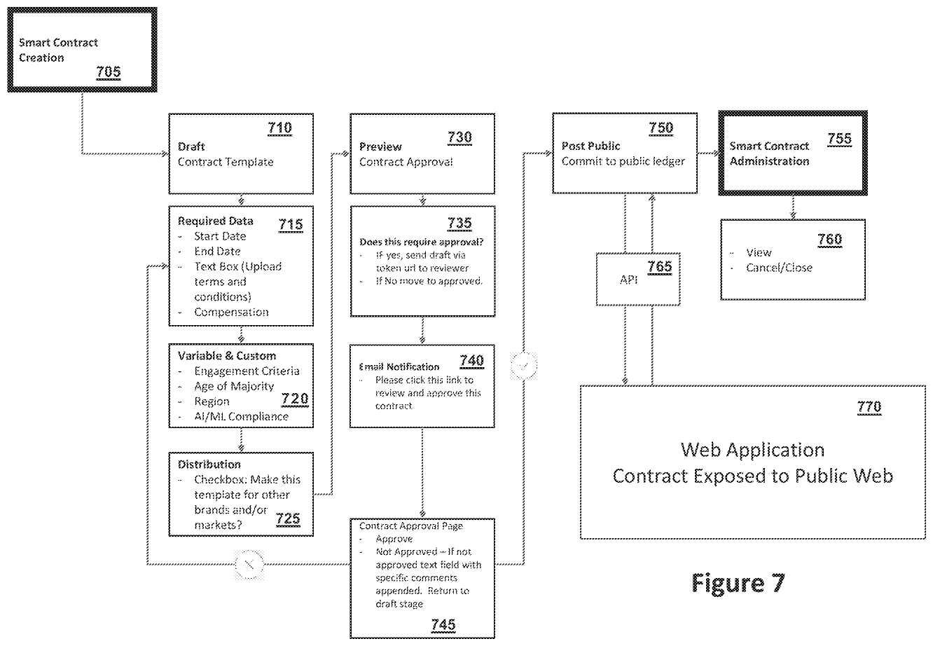

With the user account in the system, the contracts may then be created at 705 as shown in FIG. 7. A contract may be based on a pre-loaded contract template 710 which includes required 715 and variable (customizable) data 720. Some types of required data 715 may include contract start date, contract end date, standard terms and conditions (as provided by either party or by the system) and compensation. Some types of variable data 720 may include engagement criteria (measurement), age of majority requirements (e.g., terms applying to advocates under the age of majority), region coverage, and legal/regulatory compliance terms (e.g., AML). The contract may also carry a distribution tag 725, where the contract may be flagged for use as a template for other contracts such as with other brands held by the same owner, or in other regions.

For example, a contract may include requirements for the advocate to take specific actions (e.g., a blog post or social media post related to the brand) along with agreement to submit proof of actions and to monitoring of related accounts to ensure compliance. Similarly, the terms and mechanism of payment are agreed to, and the business or agency provides proof of payment and may also agree to monitoring. If desired, more specific requirements may also be included, such as images and other specified content, metadata and hashtags associated with content, and analytics used by the parties to assess results. Any other contract requirements, including deadlines and frequency of posts may also be added to the compliance requirements and monitored accordingly. A variety of payment methods can be implemented, such as a commission model or an affiliate model.

Once the contract is created, contract approval 730 may be determined, if required. When approval is required 735, the draft contract is sent (e.g., via email with a secure link 740) to the approving party. If approval 745 is received from all required parties, then the contract is finalized and committed to the ledger 750. If approval 745 is not revised, then the contract is returned to draft 710, possibly with specific comments or changes revised through the approval process, if provided. A web application can be used at 770 to send and receive data from the public ledger using an API 765. For example, at 770, a user can access a contract committed to the ledger in the blockchain network, where the contract is a public contract as determined by permissions that configure access to blockchain network (e.g., permissions that are managed by a Hyperledger Fabric). A Hyperledger Fabric can be configured to perform a check on the identity the requesting user (e.g., request and verify its identity; compare identity data received from the user with data stored in or accessible by the Hyperledger Fabric using rules for determining and setting permissions; etc.) and provide access to a contract as requested if the requesting user identity passes the check.

At 755, a user can manage one or more smart contracts committed to the ledger, for example, perform operations or manipulations 760 such as view, cancel, close, or revise the contract. Any changes (e.g., newly generated data relating to the contract) can be validated and committed to the ledger according to some embodiments.

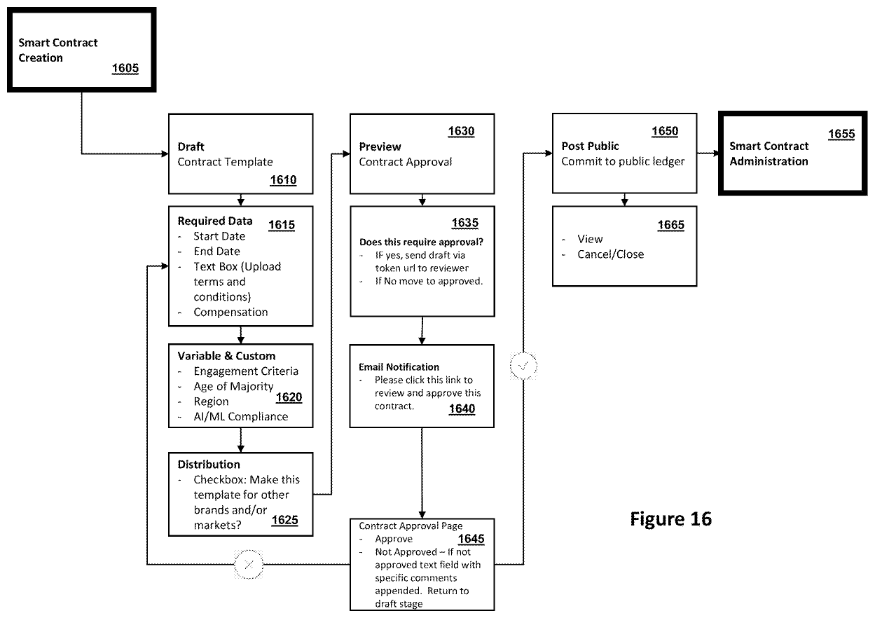

With reference to FIG. 16, in some embodiments, the system implements a workflow 1605, 1610, 1615, 1620, 1625, 1630, 1635, 1640, 1645, 1650, and 1655 similarly to that described in reference to the embodiments illustrated with reference to FIG. 7 at the corresponding stages. Further, the embodiments illustrated in FIG. 16 may instead allow for one or more smart contracts to be viewed or cancelled/closed at 1665 following committing to a public ledger at 1650. For example, embodiments illustrated in FIG. 16 may omit workflow steps corresponding to 760, 765, and 770, for example.

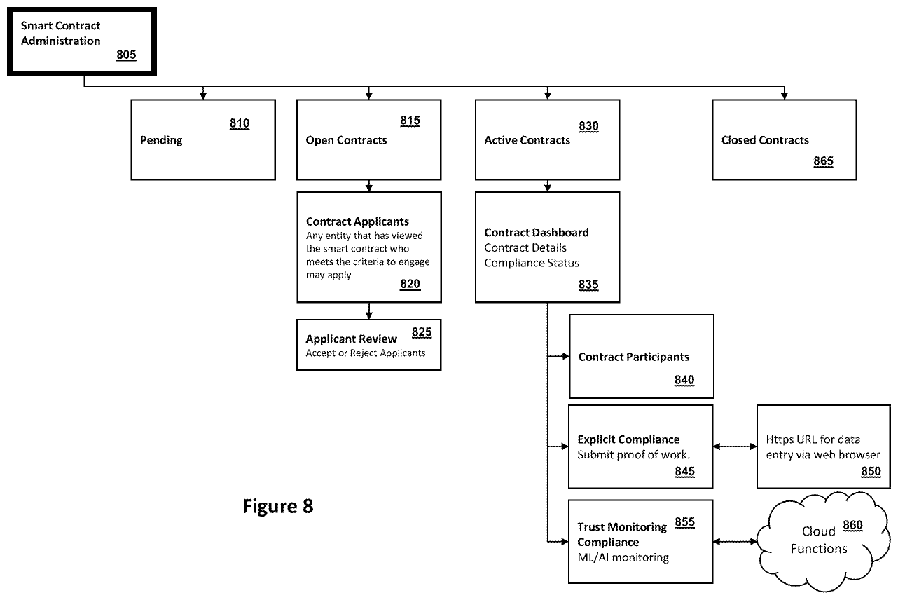

Once committed to the ledger, in some embodiments, the contract moves to administration 805 to enable monitoring and tracking as shown in FIG. 8. Under administration, contracts are classified into four categories: Pending contracts 810, Open Contracts 815, Active Contracts 830 and Closed contracts 865. Pending contracts 810 are indications of intent to develop a contract or template. Closed contracts 865 are those which are terminated, either by action of one or both parties, or by end of term. Information from closed contracts 865 may be archived, however they are effectively removed from the ledgers to free up data space and processing power and time.

Open contracts 815 are those which are awaiting approval from one of the contract parties 820 as discussed above. An allocation is made in the ledger for the approved contract and for monitoring approval or rejection 825, and any associated revisions.

Active contracts 830 are contracts which are being actively monitored and tracked in the ledger. The approved contract details are stored in the ledger 835, including the compliance requirements and terms as discussed above. The contract participants 840 are identified and have corresponding identification data stored to permit the participants to access the contract details and, in particular, to submit data with respect to contract compliance 845 (or non-compliance) as required (e.g., via a secure URL and user interface 850). System monitoring 855 for compliance is also incorporated, along with any machine learning or AI components that are to be applied to the monitoring. In some embodiments, a proof of work is submitted by an advocate as evidence that can be used to show that they have complied with a term of a smart contract.

The system compliance monitoring 855 component may be cloud-based 860 in order to track and share data for developing a trust level for the contract participants. For example, the influencer's social media account may be monitored via a machine-learning algorithm which is seeded with initial relevant terms (e.g., the name of the brand and possibly other competing brands) and track appearances of those terms in the social media account and match the other content present with the terms in order to determine if compliance with requirements for the use of the brand is being complied with by the influencer. In some embodiments, the AI is trained on data that relates use of a brand name in a sentence with a positive or negative portrayal in order to determine whether the brand name is being favourably portrayed in new sentences.

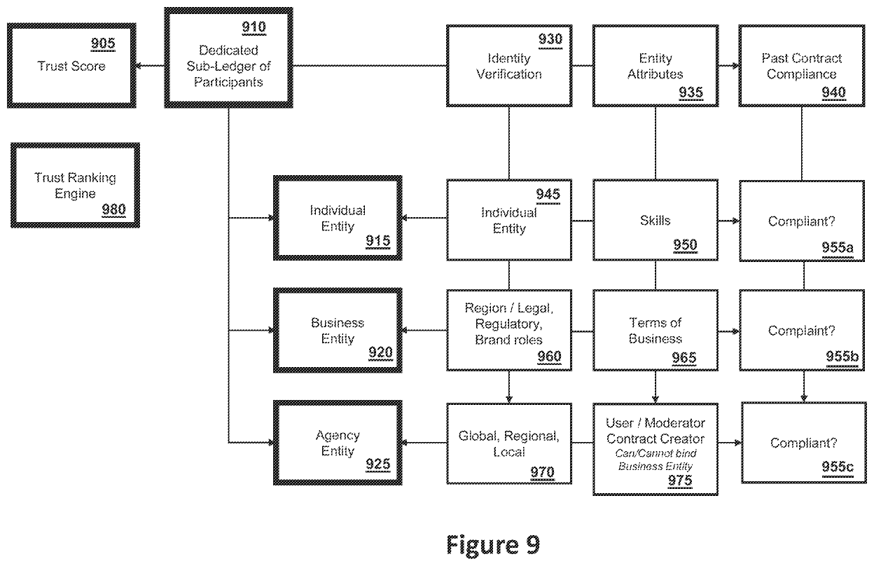

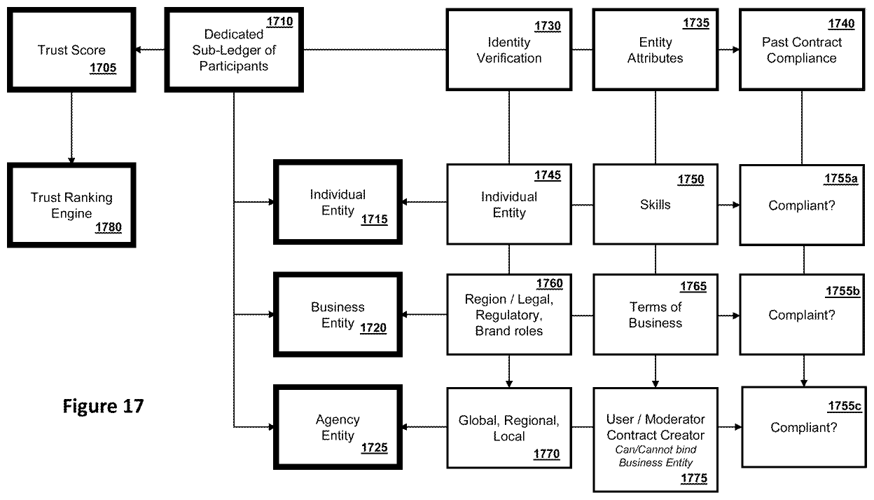

From this process, as shown in FIG. 9, a My Trust Score™ 905 may be created that is associated with the contracting parties. In some embodiments, the association is stored on the blockchain in a subledger 910. A sub-ledger 910 is kept in the system which tracks all of the participants, which are divided into three categories: individual entities 915 (for example, advocates), business entities 920 (for example, brand owners) and agency entities 925 (generally third parties such as legal counsel or collectives). Each entity is further tracked with three elements: identity verification 930, entity attributes 935 and past contract compliance record 940. In some embodiments, there is provided a trust ranking engine 980. Trust ranking engine 980 can rank My Trust Scores™ of one or more parties. FIG. 17 is a schematic diagram of an example embodiment where trust score 1705 is provided directly to trust ranking engine 1780 as shown in FIG. 17. The workflow and architecture illustrated at 1710, 1715, 1720, 1725, 1730, 1735, 1740, 1745, 1760, 1770, 1750, 1765, 1775, and 1755a, 1755b, and 1755c may operate as described in relation to corresponding stages shown in FIG. 9.

For greater clarity, a My Trust Score™ may be calculated as a series of points which can be summed to create an absolute value which is represented to a total score, for example 700 points similar to a FICO score or a letter grading system (e.g., A+, B). In particular, each entity on the network can receive a unique blockchain ID and a My Trust Score™ may rise and fall as each entity completes various transactions on the network. For example, two parties can enter into a contract on the platform where Party A offers a contract and Part B accepts the contract. Party B may successfully complete the contract offered by Part A. Party B would receive a boost in the form of 50+ points to their basic My Trust Score™. Similarly, if Party B failed to complete their contract they would have their score reduced by 50 points. Due to the unique nature of the blockchain system, Party C can examine the transactions between Party A and Party B and trust and verify each step of the transaction between both parties without knowing the contents of the contract itself.

For greater clarity, each entity may receive a public profile on the WWW presented by http://www.mytrustscore.com/USER_ID. In some embodiments, this is URL is a public presentation of data stored and verified on the blockchain accessed via API. In a fully distributed ledger model, multiple entities may hold their own private keys and update the ledger directly. For example, individual users may hold their privates on a crypto wallet on a smartphone. Viewing and applying to contracts on the platform can be contingent upon having a verifiable private key on their local device.

Thus, for an individual entity 915, identity verification 930 is based on confirming the identity of the individual, generally through a form of government-issued identification, which is recorded and stored in the ledger in association with the individual entity 945. The entity attributes for the individual would generally include the skills and expertise of the individual 950, such as subject matter (e.g., kitchen utensils) and social media network affiliations. Finally, past contract compliance 940 is a tracked record of compliance 955 (e.g., 955a, 955b, or 955c) with the terms of past contracts stored in an accessible manner. The compliance 955 may be tracked as an absolute value, percentile ranking, or as a record of exceptions, or by other methods that serve to separate more compliant entities from less compliant ones, herein referred to as a My Trust Score™ 905.

For business entities 920, identity verification 930 is based on business records and may include region legal and regulatory information 960 (i.e., location of incorporation), as well as brands associated with the entity. Agency entities 925 are similar, with additional allowance for international or multi-region affiliations 970. Attributes for business and agency entities are generally tied to their contract terms 965, particularly compliance requirements, and ability to bind 975 themselves or other parties to a contract. As with individuals 915, the record of contract compliance 940 is also tracked for business 920 and agency entities 925.

The Hyperledger framework (e.g., through permissions control logic) may further allow for control over who is allowed into their node on the Hyperledger 305 and subsequent routing and permissions related to a question, where the question may be handled by: 1) an employee; 2) a customer; or 3) a trusted advocate (an outside third party) 1045. Thus, for example, the brand may be a product retailer, a customer could be a past purchaser of products from that retailer, and a trusted third party 1045 could be another brand which is carried or provided by the product retailer or an third party whom the product retailer has allowed to answer questions as an outside trusted third party, using the trust network process described herein.

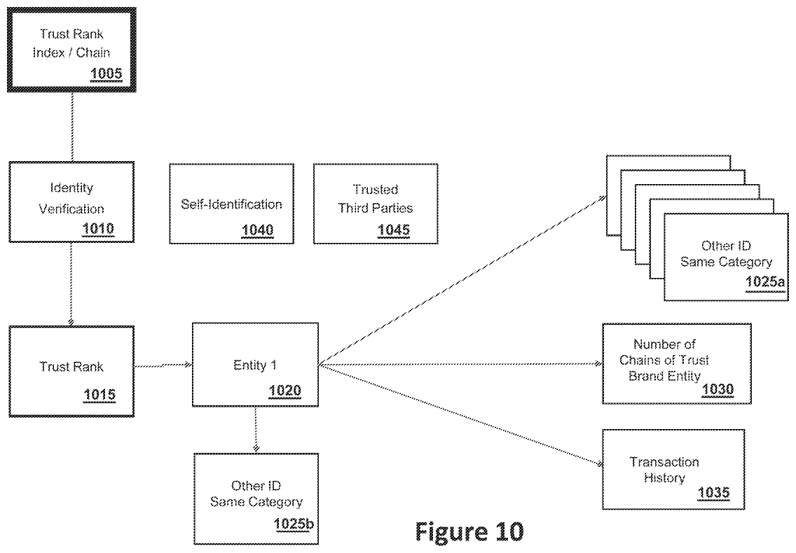

The My Trust Score™ 905 may be further applied to create a trust index or trust chain 1005 as shown in FIG. 10. With the trust index 1005, in addition to the elements discussed above, an entity 1020 may have its My Trust Score™ 905 adjusted based on relationships (“chains”) 1030 to other entities 1025. The chains 1030 may then be part of calculating a My Trust Score™ based on interactions between entities 1020.

In some embodiments, the trust index or trust chain 1005 process proceeds as follows. At 1010, the trust chain 1005 component verifies the identity of a user (e.g., receives digital identity data). At 1015, the trust chain 1005 component ranks the My Trust Score™ of the user based on one or more other entities 1020 or its own entity data 1020, for example, data indicating the entities 1020 are in the same category 1025 (or categories 1025a, 1025b, etc.) as the user, indicating the number of chains of trust 1030 associated with the entity 1020, and/or indicating a transaction history 1035 of the entity 1020. In some embodiments, the trust index or trust chain 1005 processes self-identification 1040 and/or receives verification data from trusted third parties 1045, for example, as part of the identity verification algorithm 1010.

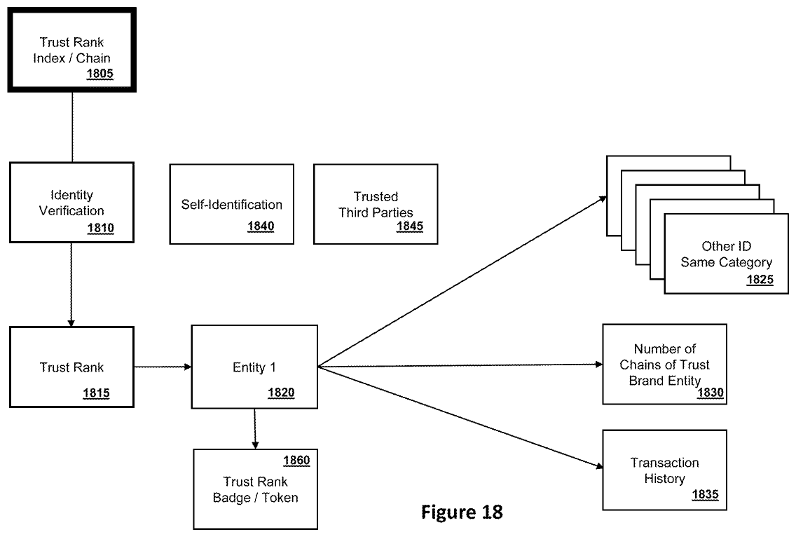

FIG. 18 is a schematic diagram of an example embodiment where Entity 1 1820 is provided with a trust rank badge or token 1860. The workflow and architecture illustrated at 1805, 1810, 1815, 1830, 1835, 1840, 1845, 1825, 1830, and 1835 may operate as described in relation to corresponding stages shown in FIG. 10.

Within the context of banking there is a well known and understood set of parameters for establishing credit scores and any weighting related to parameters in the financial world. The same cannot be said with contracts and user generated content as the performance and weighting may be highly subjective. In order for the platform to operate correctly the system needs to be transparent on the calculation of your public scores, but the agencies and brands may not want to make all of their score-relevant data public. Cryptography has a solution for this problem called zero knowledge proofs (ZKPs). A ZKP allows a party to assert some information about some data without having to reveal the data. The data model, algorithms and code could be open source so that they could be trusted to generate the correct ZKP results.

In the proposed system, if multiple parties contribute their respective inputs to a function that computes a combined score, they will have to reveal their inputs for the computation to be carried out. Alternatively, should they desire to keep in information private the platform could adopt secure multi-party computation (MPC) which would allow multiple parties to contribute their encrypted input to the computing function in a privacy-preserving mode. In other words, the respective inputs are never observed in unencrypted form outside of their origin and yet they can be used in a computation to obtain the combined score.

Another method to assist using confidential data on a public blockchain could include homomorphic encryption. The data could be constructed in a way that it can be encrypted for use outside of the originating brand or agency and you could use that encrypted data to build the score without having to first decrypt it. This is anonymized access to data for analysis by third parties. A homomorphic encryption is designed in such a way that certain operations on the input translates on analogous operations on the output. Hence, one could apply those operations on the encrypted information which simply correspond to the operations on the decrypted information.

The addition of digital signature protocols may be required allowing potentially competitive companies to collaborate without revealing who the signing parties are. This would use this to ensure integrity on data made available for public calculations but keep the originator of the data confidential. A threshold scheme whereby any k out of m parties could produce a valid signature could be enacted to ensure that only a small percentage of the transactions are private.

For example, the My Trust Score™ 905 may start with a value of 1 (representing 100%) as a global value. The global value may then be comprised of many different variables. That is, each entity may have a global value for a My Trust Score™ 905, but may also be assigned secondary rankings or My Trust Scores™ based on different factors or topics which could be either qualitative (sentiment analysis) or quantitative values. One example could be a quantitative value be comprised or derived from, but not limited to, feedback received from chat engagements by an advocate while under contract with a brand.

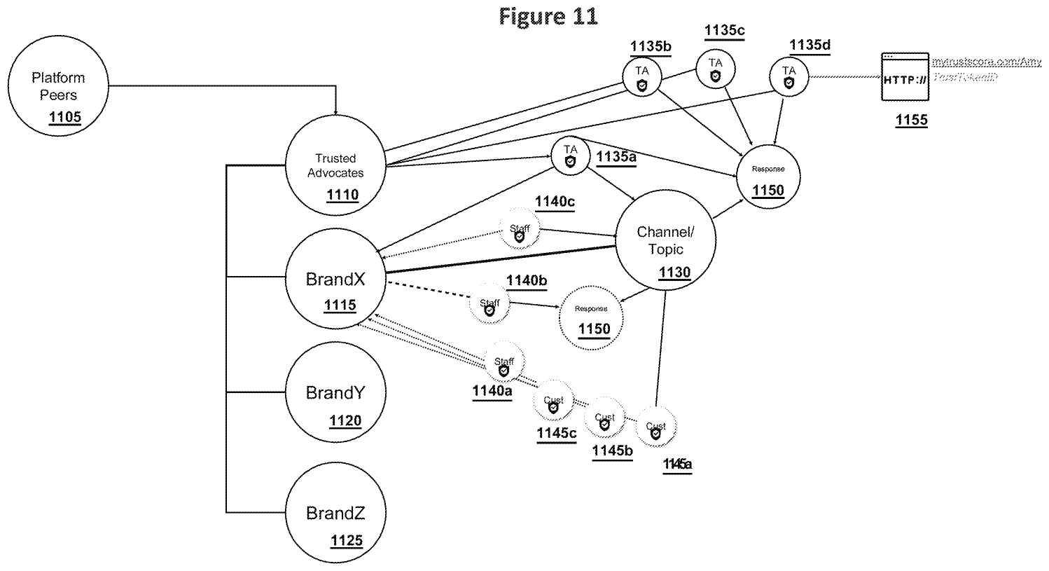

According to an embodiment, FIG. 11 is a diagram showing how the Hyperledger framework may allow multiple companies 1105 to control who is allowed into their node on the Hyperledger 305 and subsequent routing and permissions related to a question being handled by staff 1140 (e.g., 1140a, 1140b, 1140c) of a brand 1115 or 1120 or 1125, etc., a customer 1145 (e.g., 1145a, 1145b, 1145c) or a trusted advocate 1110 (i.e., an outside third party). For example, the brand 1115 could be a retailer, like a Home Depot™, a customer 1145 could be a past purchaser of products from that retailer, and a trusted third party 1135 (or third parties 1135a, 1135b, 1135c, 1135d) could be another brand 1120 which is carried by Home Depot™ or a service provider, such as an electrician, whom Home Depot™ has allowed to answer questions as an outside trusted third party. FIG. 11 also demonstrates an example of how, in some embodiments, the framework enables a use case in which Hyperledger Fabric is used to objectively map and enforce permission based relationships between entities in addition to specific permissions related to a specific channel or topic 1130 related and lastly recording the performance of a specific individual (e.g., staff 1140 or advocate 1110) related to a specific response 1150. In some embodiments, a user can request a My Trust Score™ for a trusted advocate 1110 by accessing a URL 1155.

The implied framework demonstrates how Hyperledger Fabric in FIG. 11 demonstrates how Hyperledger Fabric can deliver contracts between multiple parties, open authentication between said parties so as so expose specific roles and activities, and track the behavior and fulfillment of said activities which may in turn form the basis of a scoring the performance of an individual member who is party to the network.

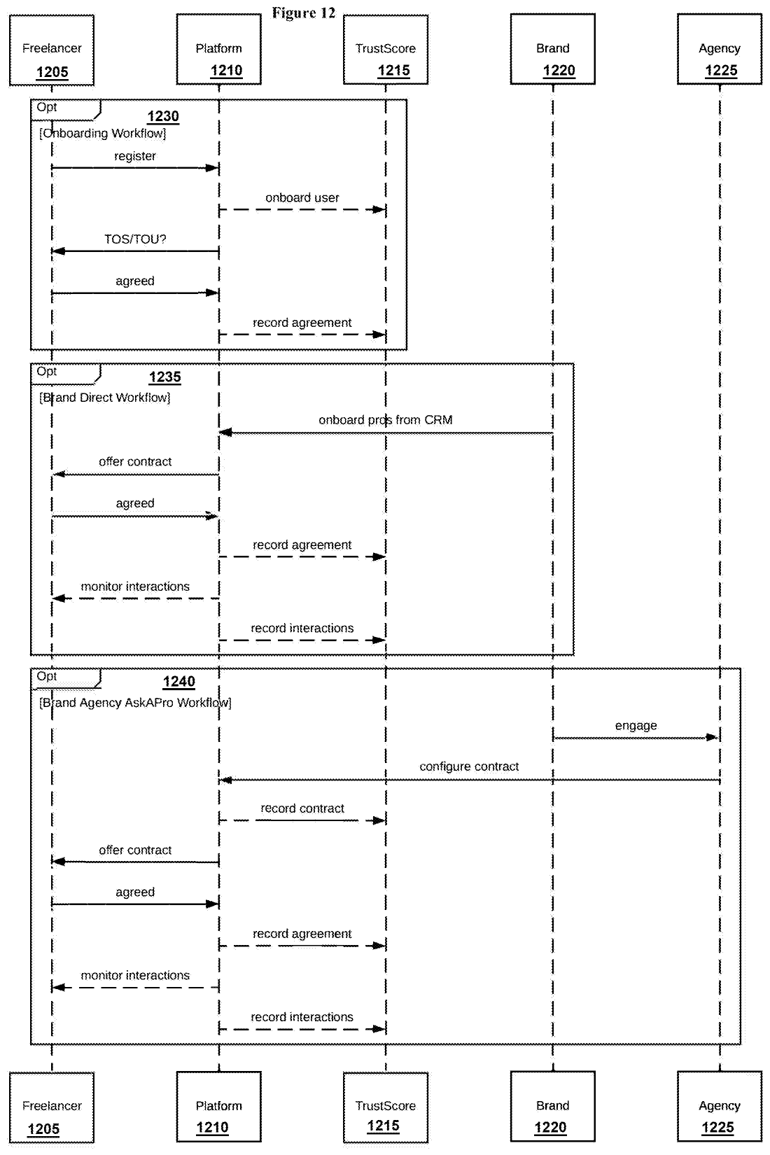

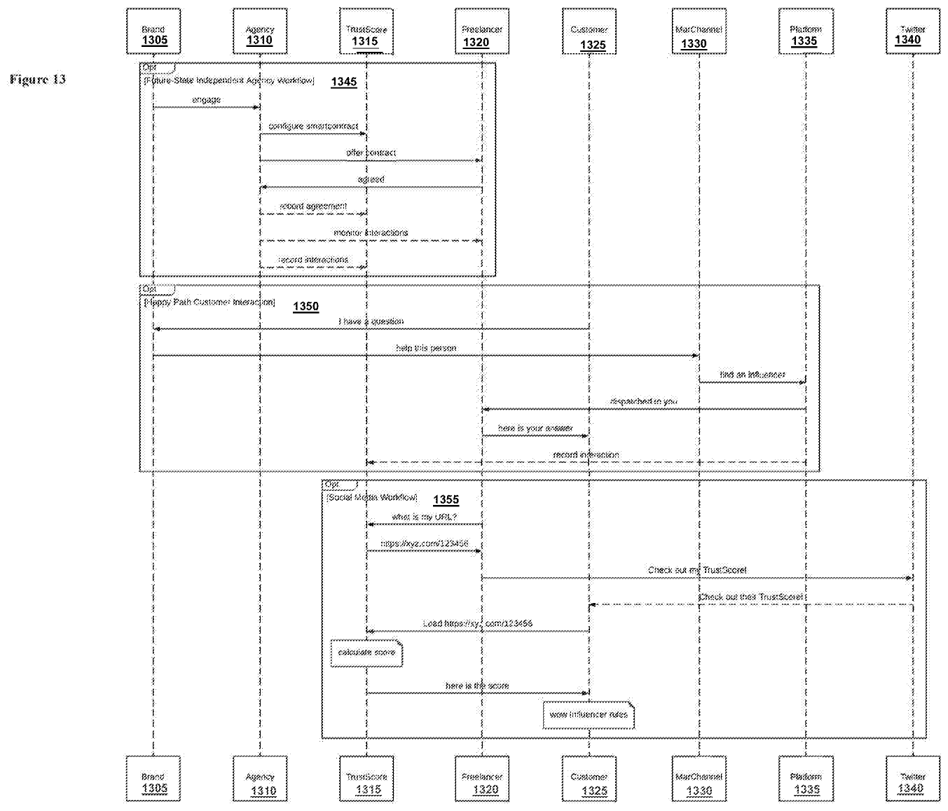

According to an embodiment, FIGS. 12 and 13 depicts a number of workflows between various parties and system components according to embodiments.

A shown in FIG. 12, from left to right, the parties and system components are: Freelancer 1205, Platform 1210, TrustScore 1215, Brand 1220, and Agency 1225. In the topmost example Onboarding Workflow 1230, the Freelancer 1205, such as an expert advice provider registers with a software-based platform such as Answerable™ which onboards the user to having a TrustScore 1215. The Freelancer 1205 agrees to an agreement from the Platform 1210 and the agreement is recorded with TrustScore 1215 software component.

Below that, an example Brand Direct Workflow 1235 is shown, the Brand 1220 onboards pros (or third party experts), from its Customer Relationship Management system and offers them a contract, which when agreed to by the Freelancer 1205 (or third party expert) is recorded with the TrustScore 1215 software component. The Platform 1210 then monitors interactions by the Freelancer 1205 and records them with TrustScore 1215 software component.

Below that, in the example Brand Agency Answerable™ Workflow 1240, the Brand 1220 first engages the Agency 1225 and then the Agency 1225 configures a smart contract in the Platform 1210 and adds it to TrustScore 1215 software component, the Platform 1210 then offers the contract with the Agency 1225 to the Freelancer 1205 and next the Freelancer 1205 agrees to the contract with the Agency 1225 through the Platform 1210. The Platform 1210 then records the agreement with the TrustScore 1215 software component and the Platform 1210 then monitors interactions by the Freelancer 1205 and records interactions with the TrustScore 1215 software component as input to calculating the Freelancer's 1205 My Trust Score™.

As shown in FIG. 13, in the example Future-State Independent Agency Workflow 1345, the Brand 1305 first engages the Agency 1310 and then the Agency 1310 configures a smart contract and adds it to the TrustScore 1315 software component. The Agency 1310 then offers the contract to the Freelancer 1320 such as an influencer and next the Freelancer 1320 agrees to the contract with the Agency 1310. The Agency 1310 then records the agreement with the TrustScore 1315 software component and the Agency 1310 then monitors interactions by the Freelancer 1320 and records the interactions with the TrustScore 1315 software component.

Below that, in the example Happy Path Customer Interaction Workflow 1350, the Customer 1325 has a question for the Brand 1305 and Brand 1305 asks through a Marketing Channel 1330, for instance, Intercom™, for someone to help this person such as an expert advice provider. The Marketing Channel 1330 submits a request to the Platform 1335 to find a Freelancer 1320 and the Platform 1335 dispatches the question to a Freelancer 1320 and the Freelancer 1320 provides an answer to the Customer 1325. The Platform 1335 then records the interaction by the Freelancer 1320 with the TrustScore 1315 software component.

Below that in the Social Media Workflow 1355, the Freelancer first asks the TrustScore 1315 software component what is my URL? and the TrustScore 1315 software component responds with the Freelancer's 1320 URL that indicates his or her My Trust Score™ The Freelancer 1320 then promotes his or her My Trust Score™ on social media such as Twitter 1340 and the Customer 1325 checks out the Freelancer's 1320 My Trust Score™ which is accessed via the Freelancer's 1320 URL. When the URL is accessed, TrustScore 1315 calculates the My Trust Score™ as described elsewhere herein and provides it to the Customer 1325 who then may assess the level of trust others have in the Freelancer 1320.

The preceding set of workflows provide examples of sequences which ultimately show how My Trust Score™ is calculated based on interactions. For example, a My Trust Score™ may start with a value of 1 (representing 100%) as a global value. That global value could be comprised of many different variables and demonstrate the relationship of authority between people. That person may have a global value, but secondary rankings or My Trust Scores™ may be assigned based on different topics. Those rankings are derived from, but not limited to, feedback received from chat engagements. As an example, if an advocate mentions the brand that they have entered into a smart contract with to promote that brand and releases a statement on their social media account promoting that brand, but also includes a statement promoting a competitor brand, the system may decrease the advocate's My Trust Score™ and/or interpret and record data indicating same as a negative interaction.

FIG. 14 is a schematic diagram of an example platform 1400 according to some embodiments. In some embodiments, platform 1400 generates a My Trust Score™ as illustrated. Platform 1400 includes a virtual machine, cloud computer, or remote computer 1410 accessible by platform 1400. Platform 1400 includes a processor, which executes instructions in memory to configure cloud computer 1410. Cloud computer 1410 receives a request to generate (e.g., compute) a My Trust Score™ and activates My Trust Score™ Cloud Function “Chron Job” 1420. The request can be generated at a node in a Hyperledger Fabric by an entity (individual, business, agency, etc.), user, or customer. For example, a user may trigger a request upon accessing a URL provided by an advocate on social media who wishes to advertise their My Trust Score™. As another example, a business entity such as Pepsi™ may be represented as or control a node in a blockchain network and may have permissioned access to specific blocks on the blockchain or data on the ledger that are not accessible by other nodes or companies based on data (e.g., digital identity) and permissions implemented by a permissioned blockchain network such as a Hyperledger Fabric. The node controlled by Pepsi™ can generate the request based on data stored in the ledger that the node has permissioned access to. As another example, an application may generate the request for a My Trust Score™ based on My Trust Score™ data, such as My Trust Score™ data generated by one or more business entities such as Pepsi™ and based on private My Trust Score™ generation algorithms. The application can receive global My Trust Score™ values about a particular supplier from computers controlled by different business entities and accordingly use the My Trust Score™ values to generate a shared My Trust Score™ value through a request that activates function 1420. The My Trust Score™ values can be validated and committed to the ledger according to some embodiments.

Function 1420 is executed based on attributes, such as time 1460 or event 1470. Example events include when a contract is completed. For example, cloud computer 1410 can receive data (e.g., with the request for a My Trust Score™) from a ledger storing the status of or indication of compliance with a contract.

In some embodiments, function 1420 receives data representing one or more user tables 1430 that store or encode data related to a user 1440. In some embodiments, user table 1430 can contain data, such as references, that can be used to request data from a sub-ledger of participants 1470. As examples, the data stored or encoded in the user table 1430 or accessible using user table 1430 can represent a trust rank badge, token, or My Trust Score™ 1450. The trust token 1450 can include an individual aggregate score 1490, an individual specific score 1405, and/or an indication 1415 of a score relative to scores for other users or people. The indication 1415 can be data generated using regression analysis, for example.

In some embodiments, function 1420 receives, implements, and/or executes one or more scoring algorithms 1480. In some embodiments, the scoring algorithms 1480 can implement open standardized score, custom scoring, and/or encrypted or private scoring. For example, an encrypted scoring algorithm can be used where a node on the network controlled by a business entity such as Pepsi™ requests the generation of a My Trust Score™ based on data kept private by permissions implemented by a blockchain network such as a Hyperledger Fabric.

In some embodiments, function 1420 receives other data such as internal data 1425 stored on data storage in cloud computer 1410 or received by cloud computer 1410. In some embodiments function 1410 receives other data such as external data 1435, for example, transmitted over a network where the transfer is implemented using a REST API 1445. In some embodiments, the system is operable to using a variety of trust scores.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, and technological advances, other methods are understood to be taught herein.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

1. A system of monitoring contract compliance, comprising:
a user interface, the user interface providing account creation and system access for individual or business users;
an application layer including access to contract creation, revision and approval tools; and
a Hyperledger Fabric blockchain network including a component for monitoring contract term compliance by contracting parties and a trust score component to assign a trust score to each party based on monitored contract compliance,
wherein the contracting parties include a party desiring services to be provided and a service provider contracted to provide the services for the contracting party.

2. The system of claim 1, wherein the account includes one or more contracts.

3. The system of claim 2 wherein at least one of the one or more contracts is an open or pending contract.

4. The system of claim 1, wherein the application layer further includes a database for storing one or more contracts.

5. The system of claim 1, wherein the application layer comprises application logic for interfacing with the user interface and the Hyperledger Fabric blockchain network.

6. The system of claim 1, further comprising an application configured to permit the service provider contracted to view his or her trust score.

7. The system of claim 1, further comprising an application configured to allow a service provider willing to promote a brand to accept engagements from a brand owner.

8. The system of claim 7, further comprising an application configured to allow a brand owner to enter into engagements with a service provider willing to promote a brand.

9. The system of claim 1, wherein the party desiring services to be provided includes an agency which represents the party.

10. The system of claim 1, wherein the monitored contract compliance uses machine learning or artificial intelligence in determining a trust score for the service provider contracted to promote a brand.

11. The system of claim 1, wherein the system includes the contract creation, revision and approval tools.

12. The system of claim 1, wherein the identity of a user is verified during account creation.

13. The system of claim 1, wherein the party desiring services to be provided is an owner of one or more brands.

14. The system of claim 13, wherein each of the one or more brands may be associated with one or more countries in which the brand is promoted.

15. The system of claim 14, wherein an agency may be given access to the brand of a business entity in one or more countries in order to enter into engagements with a service provider willing to promote a brand.

16. The system of claim 1, further comprising a contract administration tool.

17. The system of claim 16, wherein the contract administration tool is configured to permit the service provider contracted to promote a brand to submit proof of work to demonstrate contract compliance.

18. The system of claim 1, wherein approved contracts are committed to a ledger on the Hyperledger Fabric blockchain network.

19. The system of claim 1, wherein the service provider contracted to promote a brand is a social media influencer.

20. (canceled)

21. (canceled)

22. The system of claim 1, further comprising a verification component for verifying digital identity data received from one or more parties and committing the digital identity data to a ledger on the Hyperledger Fabric blockchain network.

23. The system of claim 1, wherein the Hyperledger Fabric blockchain network controls access to one or more contracts based on a permission indicator related to a digital identity of one or more parties.

24. The system of claim 1, wherein, in response to a request received through the user interface, the application layer provides validation of an identity of one or more of the parties based on one or more digital identities stored on the Hyperledger Fabric blockchain network.

25. The system of claim 1, wherein the trust score is stored on a private ledger within the Hyperledger Fabric blockchain network, the private ledger accessible by one or more of the parties based on one or more permission indicators for the one or more parties.

26. The system of claim 1, wherein the trust score component generates the trust score and commits the trust score to a private ledger within the Hyperledger Fabric blockchain network, the private ledger accessible by one or more of the one or more parties based on one or more permission indicators for the one or more parties.

27. The system of claim 1, wherein the trust score component generates the trust score for one or more of the parties based on one or more received trust scores.

28. The system of claim 1, wherein the trust score component generates the trust score for one or more of the parties using at least one of a zero-knowledge proof, multi-party computation, and homomorphic encryption.

29. (canceled)

30. (canceled)

31. A method of assigning a trust score to a service provider, comprising:
for each closed or ongoing contract, the service provider has entered into with a party desiring services to be provided:
determining whether any proof of work has been submitted by the service provider,
if yes, determining using machine learning or artificial intelligence whether the proof of work submitted by the service provider is in full or partial compliance with the terms of the contract, and
assigning a compliance score based on the extent of compliance; and
aggregating the compliance scores from each of the closed or ongoing contracts and assigning a trust score to the service provider based on the aggregated compliance scores.

32. The method of claim 31, wherein a compliance score is assigned for a closed contract with no proof of work submitted.

33. The method of claim 31, wherein the service provider is a social media influencer.

34. A computer product with non-transitory computer readable media storing program instructions to configure a processor to, for each closed or ongoing contract the service provider has entered into with a party desiring services to be provided,
determine whether any proof of work has been submitted by the service provider,
if yes, determine using machine learning or artificial intelligence whether the proof of work submitted by the service provider is in full or partial compliance with the terms of the contract, and
assign a compliance score based on the extent of compliance; and
aggregate the compliance scores from each of the closed or ongoing contracts and assign a trust score to the service provider based on the aggregated compliance scores.
